(19) United States
(12) Patent Application Publication
(10) Pub. No.: US 2026/0163412 A1
(43) Pub. Date: Jun. 11, 2026

(54) A TRANSMITTER MODULE FOR RADIO FREQUENCY CHARGING

(71) Applicant: NICOVENTURES TRADING LIMITED, London (GB)

(72) Inventor: Mohammed AL-AMIN, London (GB)

(21) Appl. No.: 18/717,861

(22) PCT Filed: Dec. 8, 2022
(86) PCT No.: PCT/GB2022/053135

§ 371 Date: Jun. 7, 2024

(30) Foreign Application Priority Data
Dec. 9, 2021 (GB) 2117820.7

(51) Int. Cl. H02J 50/40; A24F 40/65; A24F 40/95; H02J 50/00; H02J 50/23; H02J 50/80; H02J 50/90

(52) U.S. Cl. CPC H02J 50/40; A24F 40/65; A24F 40/95; H02J 50/005; H02J 50/23; H02J 50/80; H02J 50/90

(57) ABSTRACT

A method for charging a plurality of devices with radio frequency signals is described. The method comprises: generating radio frequency signals for transmission by an antenna of a transmitter module; and broadcasting the radio frequency signals into an area in the vicinity of the transmitter module via an omnidirectional antenna and/or transmitting the radio frequency signals into one or more defined areas via a directional antenna.

### TECHNICAL FIELD

The present specification relates to device charging; for example for charging aerosol provision devices using to radio frequency signals.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. There remains a need for further developments in this field.

### SUMMARY

In a first aspect, the specification describes a transmitter module comprising a signal generator and an antenna, wherein: the signal generator is configured to generate radio frequency signals for transmission by said antenna to a plurality of devices for radio frequency charging, wherein one or more of the devices for charging is an aerosol provision device; and the antenna comprises: an omnidirectional antenna to broadcast the radio frequency signals into an area in the vicinity of the transmitter module; and/or a directional antenna to provide radio frequency signals into one or more defined areas.

One or more of the defined areas may be predefined. Alternatively, or in addition, one or more of the defined areas may be based on locations of identified devices for charging. The transmitter module may further comprise a sensor, wherein the sensor is configured to detect a presence of one or more devices for charging in the vicinity of the transmitter module, and output a signal indicative of the presence of said devices for use in triggering the transmission of said radio frequency signals.

The transmitter module may further comprise a communications module for communicating with the plurality of devices for radio frequency charging. The communications module may be configured communicate with the plurality of devices for radio frequency charging using one or more of radio frequency signals, Bluetooth and Wi-Fi. The antenna may be configured to broadcast radio frequency signals for radio frequency charging and to transmit and/or receive data from one or more of said devices.

The transmitter module may further comprise a detection unit to determine a presence of one or more of the plurality of devices for charging within a proximity relative to the transmitter module. The detection unit may be configured to determine a location of one or more of the plurality of devices for charging relative to the transmitter module.

The transmitter module may further comprise a multiplexing arrangement configured to provide radio frequency signals to different defined areas at different time periods. The multiplexing arrangement may be configured to prioritise one or more of said defined areas by controlling a duration of said time periods.

In a second aspect, this specification describes a method for charging a plurality of devices with radio frequency signals, comprising: generating radio frequency signals for transmission by an antenna of a transmitter module; and broadcasting the radio frequency signals into an area in the vicinity of the transmitter module via an omnidirectional antenna and/or transmitting the radio frequency signals into one or more defined areas via a directional antenna.

One or more of the defined areas may be predefined. Alternatively, or in addition, one or more of the defined areas may be based on locations of identified devices for charging.

The method may further comprise communicating with the plurality of devices for charging using a communications module.

The method may further comprise determining a location of one or more of the plurality of devices for charging relative to the transmitter module using a detection unit.

The method may further comprise identifying at least one of the a plurality of devices for radio frequency charging using an identification module.

The method may further comprise providing radio frequency signals to different defined areas at different time periods using a multiplexing arrangement. The method may further comprise prioritising one or more of said defined areas by controlling a duration of said time periods.

In a third aspect, this specification describes a computer program comprising instructions for causing an apparatus to perform a method as described above with reference to the second aspect.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIG. 2 is a block diagram of a system in accordance with an example embodiment;

FIG. 3 is a block diagram of a transmitter module in accordance with an example embodiment;

FIG. 4 is a block diagram of a system in accordance with an example embodiment;

FIGS. 5 and 6 are flow charts showing algorithms in accordance with example embodiments;

FIGS. 7 to 9 are block diagrams of systems in accordance with example embodiments;

FIG. 10 is a flow chart showing an algorithm in accordance with an example embodiment; and

FIGS. 11 and 12 are plots showing charging arrangements in accordance with example embodiments.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine.

In some embodiments, the active substance comprises caffeine, melatonin or vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50wt %, 60wt % or 70wt % of amorphous solid, to about 90wt %, 95wt % or 100wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

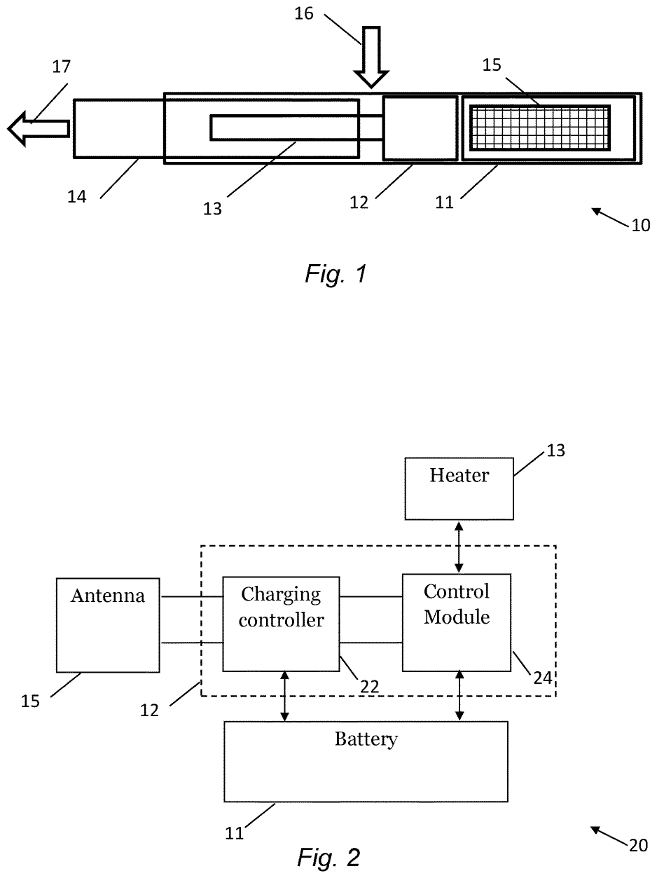

FIG. 1 is a block diagram of a non-combustible aerosol provision device, indicated generally by the reference numeral 10, in accordance with an example embodiment.

The aerosol provision device 10 comprises a battery 11, a control circuit 12, a heater 13 and a consumable 14 (e.g. a tobacco consumable, for example in the form of a tobacco stick). The device also includes an antenna 15. The example antenna 15 is shown provided near the battery 11; however, this is one of many example locations. As discussed in detail below, the antenna may be used to receive radio frequency signals for use in charging the battery 11 (e.g. under the control of the control circuit 12). In addition, the antenna 15 may be used to transmit and/or receive data, for example using one of a number of protocols (e.g. Bluetooth, Wi-Fi etc.).

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The aerosol provision device 10 is described by way of example only. Many alternative aerosol provision devices may be used in example implementations of the principles described here. For example, the device 10 may be replaced within a vaping device in which an aerosol generating material (e.g. a liquid) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.).

FIG. 2 is a block diagram of a system, indicated generally by the reference numeral 20, in accordance with an example embodiment.

The system 20 comprises the battery 11, the control circuit 12, the heater 13 (or more generally, the aerosol generator) and the antenna 15 of the aerosol provision device 10 described above. The control circuit 12 of the system 20 comprises a charging controller 22 and a control module 24.

The antenna 15 may be used to receive radio frequency signals for use in charging the battery 11 (e.g. under the control of the control circuit 12). Furthermore, the charging controller 22 may be configured to charge the battery 11 (e.g. under the control of the control module 24) with power extracted from the received radio frequency signals. As noted above, the antenna 15 may additionally be used to transmit and/or receive data.

It should be noted that, in some example embodiments, the functionality of the control module 24 is implemented by the charging controller 22. Indeed, the control module 24 may be omitted from some example embodiments.

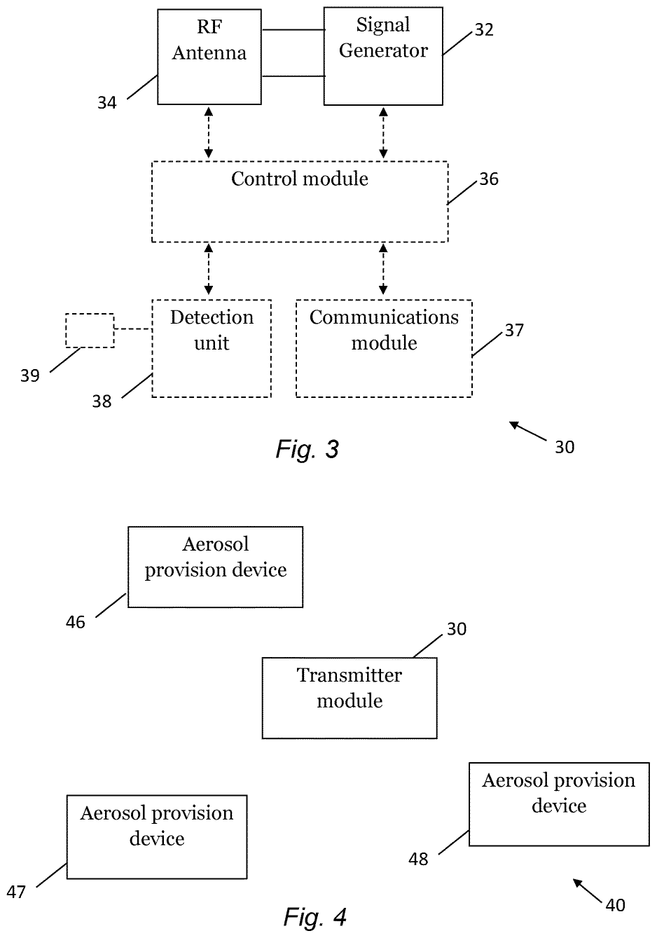

FIG. 3 is a block diagram of a transmitter module, indicated generally by the reference numeral 30, in accordance with an example embodiment.

The transmitter module 30 is configured to transmit radio frequency signals to an aerosol provision device, such as device 10 or the system 20. The transmitter module 30 comprises a signal generator 32, an antenna 34 and a power source (not shown).

The signal generator 32 is configured to generate radio frequency signals. The antenna 34 is configured to transmit the generated radio frequency signals to an aerosol provision device. The power source is configured to power the operation of the transmitter module 30. The power source may take many forms. For example, the power source may include a battery, a supercapacitor or a connector to mains power or an alternative source of power.

The radio frequency signals transmitted from the transmitter module 30 to the aerosol provision device are for the purpose of providing power to the aerosol provision device. The aerosol provision device may operate using the extracted power from the transmitted radio frequency signals.

The transmitter module 30 may further comprise a control module 36, communications module 37 and a detection unit 38.

The communications module 37 may be provided for communicating with one or more devices for radio frequency charging (e.g. using one or more of radio frequency signals, Bluetooth and Wi-Fi). The communication module 37 enables such devices to communicate information to the transmitter module 30, for example relating to one or more of: a location of a particular device for radio frequency charging; a presence of the device for radio frequency charging within a proximity to the transmitter module 30; and a charging requirement of the device for radio frequency charging.

The detection module 38 may be provided to determine the presence of one or more devices for charging within a proximity relative to the transmitter module. The detection unit 38 may also be configured to determine a location of one or more of the plurality of devices for charging relative to the transmitter. The detection unit 38 may comprise (or communicate with) one or more sensors 39 (e.g. proximity sensors) for use in determining the presence of one or more devices for charging. For example, the sensor(s) 39 in some implementations may comprise a wireless receiver configured to receive a wireless signal (such as a WiFi or Bluetooth) emitted by an aerosol provision device (e.g. for the purposes of establishing a communications link with the transmitter module 30).

The control module 36 may be configured to control the signal generator 32 and/or the antenna 34, and receive data from the communications module 37 and/or the detection unit 38.

FIG. 4 is a block diagram of a system, indicated generally by the reference numeral 40, in accordance with an example embodiment.

The system 40 comprises the transmitter module 30 that is used to generate radio frequency signals for transmission by the antenna 34 to a plurality of devices 46, 47, 48 for radio frequency charging, wherein at least one of the devices for charging is an aerosol provision device (such as the device 10 described above). The plurality of devices 46, 47, 48 are in the vicinity of the transmitter module 30 such that it is possible for the transmitter 30 to be in wireless communication with the plurality of devices 46, 47, 48 (e.g. to transmit data to and/or receive data from one or more of said devices). The transmitter module 30 may comprise: the communications module 37 (for communicating with one or more of the devices 46, 47, 48); the detection unit 38 (to determine the presence of one or more of the plurality of devices for charging within a proximity relative to the transmitter module); and the control module 36.

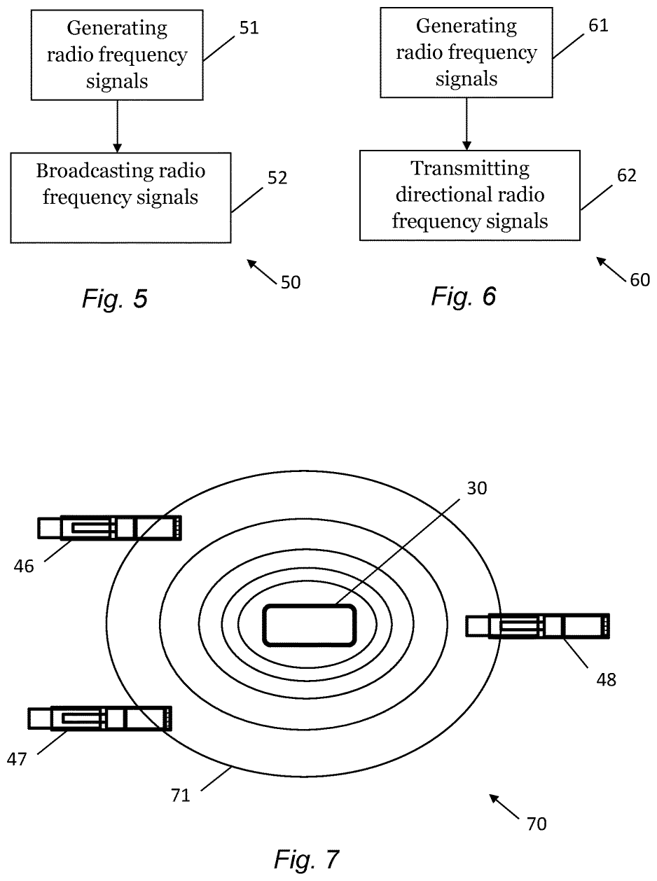

FIG. 5 is a flow chart showing an algorithm, indicated generally by the reference numeral 50, in accordance with an example embodiment.

The algorithm 50 starts at operation 51, where radio frequency signals for transmission by an antenna of a transmitter module (such as the transmitter module 30) are generated. At operation 52, the generated radio frequency signals are broadcast into an area in the vicinity of the transmitter module. As discussed further below, the operation 52 may be implemented using an omnidirectional antenna.

FIG. 6 is a flow chart showing an algorithm, indicated generally by the reference numeral 60, in accordance with an example embodiment.

The algorithm 60 starts at operation 61, where radio frequency signals for transmission by an antenna of a transmitter module (such as the transmitter module 30) are generated. The operation 61 is therefore similar to (and may be identical to) the operation 51 described above.

At operation 62, the generated radio frequency signals are transmitted into one or more defined areas. As discussed further below, the operation 62 may be implemented using a directional antenna.

FIG. 7 is a block diagram of a system, indicated generally by the reference numeral 70, in accordance with an example embodiment. The system 70 comprises the transmitter module 30 and the plurality of devices 46, 47 and 48 for charging. The system 70 may be used to implement the algorithm 50 described above.

As described above, the transmitter module 30 comprises a signal generator 32 and an antenna 34, wherein the signal generator 32 is configured to generate radio frequency signals for transmission by said antenna 34 to a plurality of devices 46, 47, 48 for radio frequency charging, wherein one or more of the devices for charging is an aerosol provision device.

The system 70 shows the transmitter module 30 broadcasting radio frequency signals 71 into an area in the vicinity of the transmitter module 30. To do so, the antenna 34 of the transmitter module 30 may comprise an omnidirectional antenna.

The transmitter module 30 may comprise the communications module 37. The communication module 37 may be configured to communicate with any devices for radio frequency charging within a proximity to the transmitter module 30. The control module 36 may use information received by the communications module 37 to identify devices within the vicinity of the transmitter module 30 and control the signal generator accordingly. For example, the control module 36 may conditionally enable the signal generator upon successful identification of a device for radio frequency charging in the vicinity of the transmitter module 30. Any of the plurality of devices 46, 47, 48 in the area in the vicinity of the transmitter module 30 would then receive the radio frequency signals 71.

The transmitter module 30 may comprise the detection unit 38. Alternatively, the control module 36 may use information received by the detection unit 38 to identify devices within the vicinity of the transmitter module 30 and control the signal generator accordingly.

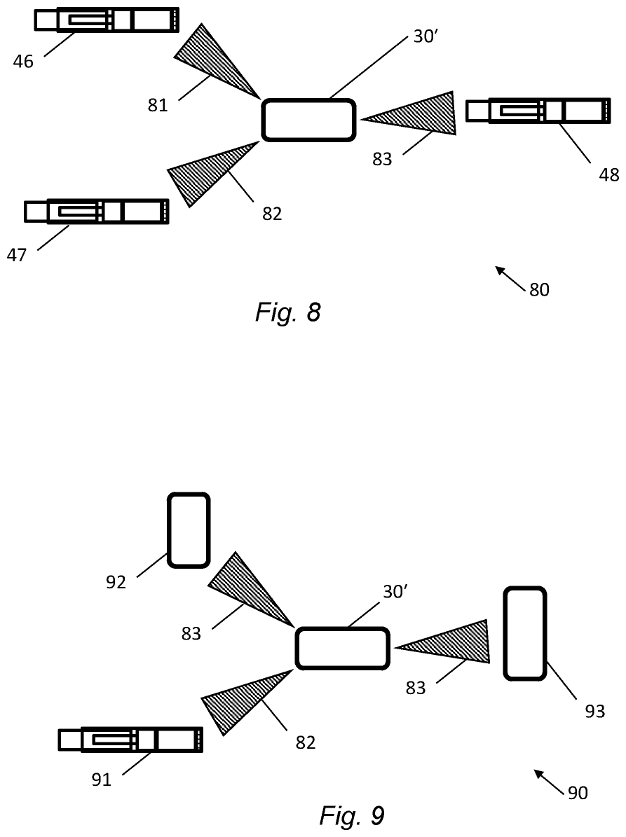

FIG. 8 is a block diagram of a system, indicated generally by the reference numeral 80, in accordance with an example embodiment. The system 80 comprises a transmitter module 30′ and the plurality of devices 46, 47 and 48 for charging, as described above. The system 80 may be used to implement the algorithm 60 described above.

The transmitter module 30′ is similar to the transmitter module 30. Specifically, the transmitter module 30′ comprises the signal generator 32 and the antenna 34, wherein the signal generator is configured to generate radio frequency signals for transmission by said antenna to a plurality of devices (such as the devices 46, 47 and 48) for radio frequency charging. Unlike in the omnidirectional antenna of the system 70, the antenna of the transmitter module 30′ is directional, such that radio frequency signals can be provided into one or more defined areas.

The system 80 shows the transmitter module 30′ providing radio frequency signals 81, 82 and 83 into areas corresponding to the locations of the devices 46, 47 and 48 for radio frequency charging. It is possible a particular defined area may comprise more than one device for radio frequency charging.

Some or all of the one or more of the defined areas may be predefined. For example, there may be areas in the vicinity of the transmitter module 30′ that are arranged to store a device for radio frequency charging or where a user is likely to place a device for radio frequency charging. Any devices placed or stored in these areas would receive the radio frequency signals 81, 82 and 83.

Alternatively, or in addition, some or all of the one or more of the defined areas may be based on locations of identified devices for charging. For example, the transmitter module 30′ may comprise the communications module 37. The communications module 37 may be configured to request data indicative to a location of devices for radio frequency charging (such as the devices 46, 47 and 48). Based on received data indicative of a location of the plurality of devices for radio frequency charging, the control module 36 may be configured to control the directional antenna to provide radio frequency signals to the area defined by the information indicative of the location of the plurality of devices for radio frequency charging.

The transmitter module 30′ may comprise the detection unit 38. Alternatively, the control module 36 may use data indicative of a location of the devices 46, 47 and 48 received by the detection unit 38. Based on received data indicative of a location of the plurality of devices for radio frequency charging, the control module 36 may be configured to control the directional antenna accordingly.

Alternatively, or in addition, the detection unit 38 may comprise (or communicate with) one or more sensors 39 (e.g. proximity sensors) for use in determining a location of one or more of said devices 46, 47 and 48.

As described above, some example transmitter module implementations include an omnidirectional antenna and some other example transmitter module implementations include a directional antenna. In some example embodiments, a transmitter module may be provided including both an omnidirectional antenna and a directional antenna. A mechanism may be provided to decide whether to use the omnidirectional antenna or the directional antenna. Such a mechanism may include a system setting (e.g. a user may indicate whether an omnidirectional or a directional mode of operation should be used). Alternatively, or in addition, the decision mechanism may be based on circumstances; for example, if a small number of devices (e.g. one or two aerosol provision devices) are to be charged, then the directional antenna may be used, but if multiple devices are to be charged (e.g. more than two), then the omnidirectional antenna may be used. Alternatively, or in addition, the decision mechanism may be dependent on whether (or how accurately) positions of devices to be charged can be determined.

As described above, some or all of the devices for charging may be aerosol provision devices; however, this is not essential to all example embodiments.

FIG. 9 is a block diagram of a system, indicated generally by the reference numeral 90, in accordance with an example embodiment. The system 90 comprises the transmitter module 30′ described above that provides radio frequency signals 81, 82 and 83 into area corresponding to locations of devices for charging. The system 90 differs from the system 80 only in the nature of the devices for charging.

In the system 90, the plurality of devices for charging include an aerosol provision device 91 and two other devices 92 and 93 (such as mobile phones or laptops). Of course, any combination of devices could be charged in this way.

Although the system 90 includes the transmitter module 30′ having a directional antenna, the transmitter module 30 having an omnidirectional antenna may be used in a variant of the system 90 (in order, for example, to implement the algorithm 50 described above).

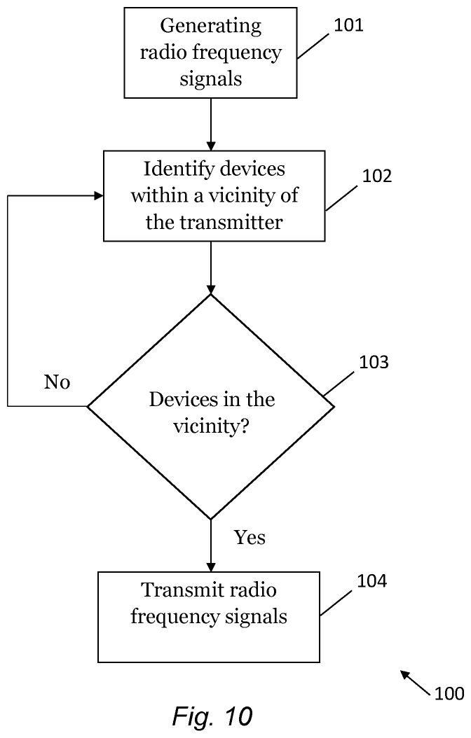

FIG. 10 is a flow chart showing an algorithm, indicated generally by the reference numeral 100, in accordance with an example embodiment. The algorithm 100 may, for example, be implemented by the systems 70, 80 or 90 described above.

The algorithm 100 starts at operation 101, where radio frequency signals for transmission by an antenna of a transmitter module (such as the transmitter module 30 or 30′) are generated. The operation 101 may therefore be the same as the operations 51 and 61 described above.

At operation 102, a determination is made regarding whether devices for charging are within the vicinity of the transmitter. For example, devices may be identified. Alternatively, or in addition, the presence of one or more devices may be determined, for example using a sensor, such as a proximity sensor. If devices are identified, then the algorithm moves to operation 104; otherwise the algorithm returns to operation 102.

At operation 104, radio frequency signals are transmitted (for use in charging the devices identified in the operation 102). The radio frequency signals may be broadcast (as in the algorithm 50) or transmitted using a directional antenna (as in the algorithm 60).

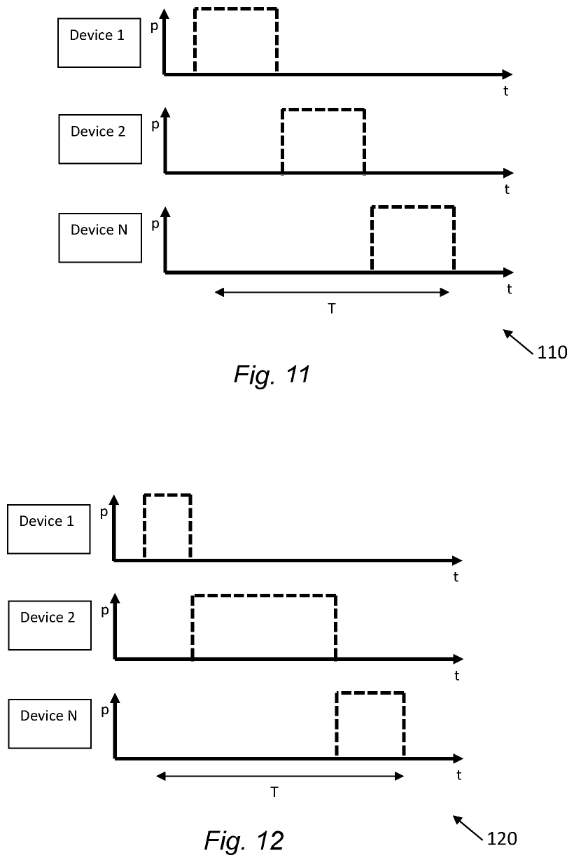

FIG. 11 is a plot, indicated generally by the reference numeral 110, showing a charging arrangement in accordance with an example embodiment.

A transmitter module (such as the transmitter module 30 or the transmitter module 30′) may comprise a multiplexing arrangement configured to provide radio frequency signals to different defined areas at different time periods. In this way, rather than constantly transmitting radio frequency signals to all the plurality of devices for radio frequency charging in a network, the transmitter module can use time division multiplexing to transmit radio frequency signals to the plurality of devices for radio frequency charging. Over a time period, defined by T, a number of identified devices for radio frequency charging, defined by N, may share the time period T for charging, receiving an allocated fraction of the time period (e.g. given by T/N). Plot 110 shows an example embodiment wherein device 1, device 2 and device N are all allocated the same calculated average charging time.

FIG. 12 is a plot, indicated generally by the reference numeral 120, showing a charging arrangement in accordance with an example embodiment.

The multiplexing arrangement depicted in the plot 120 differs from that of the plot 110 in that one of said defined areas is prioritised by controlling a duration of said time periods. In an example implementation, the communications module 37 of the transmitter module 30 or 30′ may be configured to request information indicative of a priority level for charging a given device. Based on the received priority level, the multiplexing arrangement may allocate longer than average periods of charging time to some devices for radio frequency transmission and allocate shorter than average periods of charging time to other devices for radio frequency charging. The plot 120 shows an example embodiment in which Device 2 is allocated a longer charging time than device 1 or device N.

As discussed above, electrical power may be extracted from radio frequency (RF) signals. This may be implemented in a number of ways. For example, a receiving antenna may be provided to receive the RF signals, causing a potential difference to occur across the length of the antenna. Thus, an AC (typically sinusoidal) RF signal is obtained at the antenna. This AC signal is typically converted into a DC signal, for example using a rectifier circuit (such as a full bridge or half-bridge rectifier circuit). In some example embodiments, an impedance matching circuit is provided between the antenna and a rectifier circuit that seeks to maximise power transfer from the antenna to the rectifier. The DC electrical power output by the rectifier may, for example, be stored using a battery.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A transmitter module comprising a signal generator and an antenna, wherein:
the signal generator is configured to generate radio frequency signals for transmission by said antenna to a plurality of devices for radio frequency charging, wherein one or more of the devices for charging is an aerosol provision device; and
the antenna comprises:
an omnidirectional antenna to broadcast the radio frequency signals into an area in the vicinity of the transmitter module; and/or a directional antenna to provide radio frequency signals into one or more defined areas.

2. The transmitter module as claimed in claim 1, wherein one or more of the defined areas are predefined.

3. The transmitter module as claimed in claim 1, wherein one or more of the defined areas are based on locations of identified devices for charging.

4. The transmitter module as claimed in claim 3, further comprising:
a sensor, wherein the sensor is configured to detect a presence of one or more devices for charging in the vicinity of the transmitter module, and output a signal indicative of the presence of said devices for use in triggering the transmission of said radio frequency signals.

5. The transmitter module as claimed in claim 1, further comprising a communications module for communicating with the plurality of devices for radio frequency charging.

6. The transmitter module as claimed in claim 5, wherein the communications module is configured communicate with the plurality of devices for radio frequency charging using one or more of radio frequency signals, Bluetooth and Wi-Fi.

7. The transmitter module as claimed in claim 6, wherein the antenna is configured to broadcast radio frequency signals for radio frequency charging and to transmit and/or receive data from one or more of said devices.

8. The transmitter module as claimed in claim 1, further comprising a detection unit to determine a presence of one or more of the plurality of devices for charging within a proximity relative to the transmitter module.

9. The transmitter module as claimed in claim 8, wherein the detection unit is configured to determine a location of one or more of the plurality of devices for charging relative to the transmitter module.

10. The transmitter module as claimed in claim 1, further comprising:
a multiplexing arrangement configured to provide radio frequency signals to different defined areas at different time periods.

11. The transmitter module as claimed in claim 10, wherein the multiplexing arrangement is configured to prioritise one or more of said defined areas by controlling a duration of said time periods.

12. A method for charging a plurality of devices with radio frequency signals, comprising:
generating radio frequency signals for transmission by an antenna of a transmitter module; and
broadcasting the radio frequency signals into an area in the vicinity of the transmitter module via an omnidirectional antenna and/or transmitting the radio frequency signals into one or more defined areas via a directional antenna.

13. The method as claimed in claim 12, wherein one or more of the defined areas are predefined.

14. The method as claimed in claim 12, wherein one or more of the defined areas are based on locations of identified devices for charging.

15. The method as claimed in claim 12, further comprising communicating with the plurality of devices for charging using a communications module.

16. The method as claimed in claim 12, further comprising determining a location of one or more of the plurality of devices for charging relative to the transmitter module using a detection unit.

17. The method as claimed in claim 12, further comprising identifying at least one of the a plurality of devices for radio frequency charging using an identification module.

18. The method as claimed in claim 12, further comprising:
providing radio frequency signals to different defined areas at different time periods using a multiplexing arrangement.

19. The method as claimed in claim 18, further comprising prioritising one or more of said defined areas by controlling a duration of said time periods.

20. A computer program comprising instructions for causing an apparatus to perform the method as claimed in claim 12.
